(19) United States
(12) Patent Application Publication
(10) Pub. No.: US 2015/0269776 A1
(43) Pub. Date: Sep. 24, 2015

(54) Method for Capturing Surface Geometries

(71) Applicant: a.tron3d GmbH, Klagenfurt am Worthersee (AT)

(72) Inventor: Jurgen JESENKO, Finkenstein (AT)

(21) Appl. No.: 14/665,388

(22) Filed: Mar. 23, 2015

(30) Foreign Application Priority Data
Mar. 21, 2014 (DE) 102014103881.9

(51) Int. Cl. G06T 17/10

(52) U.S. Cl. CPC G06T 17/10; G06T 2200/04; G06T 2207/30036; G06T 2210/12; G06T 2215/16; G06T 2219/2004; G06T 2219/2008

(57) ABSTRACT

In a method for capturing the surface geometry of at least one part of an object, in particular of intraoral structures, a physical impression is first made of at least one part of the object. The surface geometry of the physical impression is captured by a scanner, either directly, or indirectly by a positive impression, during an initial scan. A virtual representation of the physical impression is thereby created, which is at least temporarily recorded on a storage medium. Additionally, the method includes:
the virtual representation is read by the storage medium and made available,
performing a second scan of the object, in which at least one section of the object which was altered or not captured by the first scan of the physical impression is captured,
updating the virtual representation of the objects by data gained through the second scan,
recording the altered virtual representation.

### FIELD OF THE INVENTION

The invention concerns a method for capturing the surface geometry of at least one part of an object, in particular of intraoral structures, from which a physical impression of at least one part of the object is first made, after which the surface geometry of the physical impression is then either directly, or indirectly via a positive impression, captured by means of a scanner during an initial scan, whereby a virtual representation of the physical impression is created, which is at least temporarily recorded on a storage medium.

### BACKGROUND OF THE INVENTION

Mapping three-dimensional objects by means of physical impressions and casts has been known for some time from the state of the art. In the course of the development of digital mapping methods, two main technical branches have been formed.

In one branch, physical impressions of the objects to be captured or the respective sections of these objects are created as before. These impressions are then captured by means of stationary scanners either directly or following the intermediate step of a positive impression. This has the advantage that the digital surface geometries obtained thereby are precise, in other words largely corresponding to the real surface geometry. This precision is primarily attributable to the ease of calibrating stationary scanners. Many data that must be elaborately measured and calculated in non-stationary scanner systems, and therefore carry a multitude of sources for error, can be provided by stationary scanners. Thus, the impression can be positioned on a rotating disk, for example, which leads to the change in the angle under which the impression is viewed being known upon analysis of exposures of the scanner. Analogously, a change in distance between exposures can be determined, for example by means of guide rails.

Stationary scanners also have various disadvantages, however. The predetermined relative position of the scanner with regard to the impression (or also to an object) can itself lead to shading, because of which sections of the impression (or also of an object) can not be measured. Additionally, the spatial size of the impression to be mapped, or, alternatively, of the object to be mapped, is limited due to the construction of stationary scanners. While the theoretical possibility of constructing individual impressions of partial sections of large objects and computationally combining the surface geometries captured thereby exists, new sources for error would, however, be created, which reduce the advantages of stationary scanners.

The second relevant branch of digitally capturing surface geometries generally entirely forgoes the creation of physical impressions. Instead, mobile, usually handheld scanners are moved directly around the object to be captured, until all desired areas are captured as a digital surface geometry. Depending on size and accessibility, an object can thereby be captured very comprehensively, but with limited precision, since the relative motion of the scanner in relation to the object is not known, but must be calculated. The measurements necessary for this harbor errors which then carry over to the calculation of the surface geometry.

### SUMMARY OF THE INVENTION

The invention therefore has the underlying goal of overcoming the disadvantages of the two mentioned systems described above.

This problem is solved according to the invention by a method of the kind described at the outset, with the attributes of the characterizing clause of claim 1.

In a method according to the invention to capture the surface geometry of at least one part of an object, particularly of intraoral structures, initially a physical impression of at least one part of the object is made, after which the surface geometry of the physical impression is then either directly—or indirectly by means of a positive impression—captured during an initial scan by means of a scanner, thereby creating a virtual representation of the physical impression which is at least temporarily recorded on a storage medium. Then the following steps take place according to the invention:
reading and making available the virtual representation from the storage medium,
conducting a second scan process of the object, wherein at least one section of the object which was altered or was not captured by the first scan process is captured,
updating the virtual representation of the object by means of data which was gained from the second scan,
recording the altered virtual representation on a storage medium.

In doing so, the order of the steps is not necessarily predetermined for all steps. Thus, the virtual representation can, for example, also be read from the storage medium and made available at the same time as the second scan is being conducted. On the other hand, updating the virtual representation only makes sense after the second scan. The possible, sensible and advantageous orders of the individual steps are apparent to a person skilled in the art and can thus be selected by him or her.

According to a preferred implementation of the method, the first scan takes place using a stationary scanner. The exceptional precision of a stationary scanner can thus be used advantageously in the method.

In an alternative, preferred implementation of the method, the first scan takes place using a handheld scanner. Larger impressions (or their positive impressions) or complicated forms can thus also be captured.

In a third “hybrid” implementation which can also be used advantageously independent of the invention, the advantages of a handheld scanner and a stationary scanner can also be combined, for instance by guiding a handheld scanner with a robot arm. Thus, the flexibility of a handheld scanner can be used if desired, while position changes of the scanner between individual exposures can be specifically selected and controlled.

In an additional preferred implementation of the method, the second scan is conducted by means of a handheld scanner. If, as is foreseen for the second scan, the object itself is scanned, it is frequently the case that not all surfaces of the object can be easily reached or seen. Thus, an impression of a tooth, for example, can easily be placed in a stationary scanner. Most intraoral structures are however part of the oral cavity or connected with it, and therefore can not be reached with a stationary scanner. Therefore, it is advantageous to capture the object itself with a handheld scanner.

In an additional preferred further development of the invention, the method can additionally include the step of visualizing the virtual representation. A user is thereby supported when using the scanner, for instance by recognizing which sections have not been captured yet or have changed since the production of the impression.

In an additional particularly preferred further development of the invention, the method can include the step of transferring the provided virtual representation into an expandable notation, in particular a TSDF. This is especially advantageous if the virtual representation, as is usual according to the state of the art, is available as an STL file which can not be amended or can only be amended with difficulty. The particular advantages of a TSDF will be discussed later.

This step can be omitted if the virtual representation is recorded directly in a notation suitable for additions. This can, for instance, be the case if the impression, as suggested above, was captured by means of a handheld scanner guided by a robot arm, which already records the virtual representation in an expandable notation. In particular, in this special case handheld scanners of the same make can be used for both the first as well as for the second scan.

In a preferred further development of the method, the transfer includes the step of determining a bounding box for the virtual representation. This step is advantageous for the transfer, since most expandable forms of notation require a defined three-dimensional space. Herein, an enclosing body around the virtual representation is determined. This enclosing body is usually a simple geometric shape, such as a sphere, an ellipsoid, a cube, a cuboid or the like, whose size is chosen to be as small as possible; the virtual representation, however, must lie entirely within the enclosing shape. The bounding box thereby forms the basis for generating the defined three-dimensional space. It is particularly preferable to thereby determine an axis-aligned bounding box. An axis-aligned bounding box is generally cube-shaped, and the edges of the bounding box lie along an orthogonal or Cartesian coordinate system.

Additionally, the transfer particularly preferably includes the step of discretizing the bounding box. Here, the bounding box is partitioned into a grid with discrete coordinates. Since discretizing is preferably performed equidistantly, an axis-aligned bounding box is particularly advantageous.

Additionally, the transfer preferably includes the step of aligning the virtual representation according to the bounding box. This is advantageous for the method, since the dimensions of the bounding box can be optimized in this manner. The optimized dimensions of the bounding box furthermore lead to an increase in performance speed (performance increase).

According to a further preferred development of the method according to the invention, the transfer includes the step of increasing the size of the bounding box. Thus, space for possible additions is created. Additionally, in systems which also take the geometry of the scanner into account when scanning, space is created for this. As was already the case for the steps of the method itself, it is also true for the substeps of the transfer that the order can be sensibly chosen by one skilled in the art. Thus, it is, for example, necessary to first determine the bounding box before it can then be discretized and enlarged, while it is only of minor importance to the transfer, whether discretizing occurs before or after enlarging the bounding box.

There are, however, systems in which a specific order of substeps for the transfer is advantageous. Thus, for example, systems in which a fixed number of grid points for each offset direction of the bounding box is required for an optimal function, benefit if the bounding box is first enlarged and then simply partitioned into the desired number of grid points. Steps of calculation can thus be saved under certain circumstances.

In an additional particularly preferred implementation of the method, the transfer includes the step of determining the distances of individual grid points of the discretized bounding box to a surface of the representation along a defined direction of the bounding box, and of noting the determined distance values in individual grid points, thus creating an SDF. This represents a preferred form of expandable notations. In a further development of this implementation, there follows a step in which determined distances which are higher than a defined value are set to the defined value, thus creating a TSDF. The TSDF gained thereby has various advantages relating to adding newly gained surface information. A preferred method of supplementing and updating visual representations which are recorded in the form of a TSDF can be derived from European patent application No. 13 450 056.0, in which the particular advantages of a TSDF are also explained further. According to the invention, supplementing and updating can be performed as in European patent submission No. 13 450 056.0. Other forms are also possible, however.

According to an additional preferred implementation of the method, the transfer can further include a step in which the algebraic sign of the SDF or TSDF is changed. In a signed distance function (SDF), the signs determine whether a grid point, also referred to as a voxel, lies before or behind the recorded surface in the direction along which the distance was ascertained (usually the z-axis of the Cartesian coordinate system which was used to create the axis-aligned bounding box). If a negative impression was mapped, it can occur that, originating from the object from which the negative impression was created, the wrong side of the captured surface is recorded as “external” in the SDF. This can lead to errors when supplementing the SDF later. These can be avoided by changing the signs of the SDF. The same is analogously true for a TSDF, in which the value of the determined distance value is limited (truncated), yet the signs have the same meaning as for the SDF.

In a further preferred development of the method according to the invention, the transfer includes a step in which the distance values recorded in the grid points are weighted. Weighting the distance values in grid points can prevent the potentially inferior second scan downgrades the surface information captured in the first scan. Particular methods and advantages of weighting distance values are also explained in detail in European patent submission No. 13 450 056.0. According to the invention, weighting can be performed according to European patent submission No. 13 450 056.0. Other forms are also possible, however.

In a further preferred implementation of the invention the method includes a step in which sections which should not be updated by scanning the altered object are marked. This step can, in particular, be performed independently of the chosen expandable notation. Generally sections are marked herein which should not be updated. This can, for example, concern empty areas which should not be falsified by inadvertent captures, for instance captures of the tongue in intra-oral applications.

Further preferred implementations of the invention are the topic of the remaining sub-claims.

Hereafter the invention is further explained by means of an exemplary implementation. A possible sequence of the method according to the invention is shown by means of a flow chart, which spans FIGS. 1 and 2.

### BRIEF DESCRIPTION OF THE FIGURES

FIG. 1 depicts a flow chart that shows in the exemplary implementation, a physical (negative) impression of the object is first created, for example by making a cast of a tooth.

FIG. 2 depicts a flow chart wherein a bounding box can be enlarged.

### DETAILED DESCRIPTION OF THE INVENTION

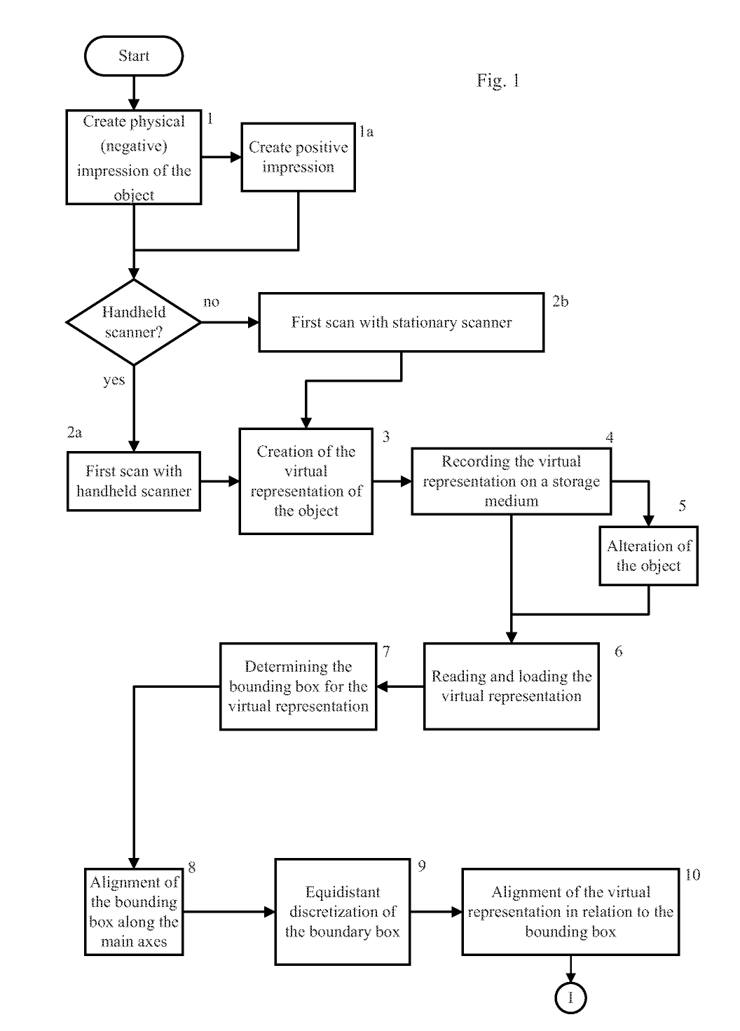

FIG. 1 shows that in the exemplary implementation, a physical (negative) impression of the object is first created 1, for example by making a cast of a tooth. Optionally, a physical positive impression can then be created la. Then, a first scan is performed for the physical impression (or for the positive impression, as the case may be). This can be done by means of a handheld scanner or a stationary scanner 2a, 2b. A virtual representation of the object is thereby created 3. The virtual representation is then recorded on a storage medium 4. The storage medium can either be a temporary storage medium, such as a RAM, or the visual representation can be recorded in a permanent fashion, for instance on a CD. Naturally hard drives, SD cards and the like are also suitable for recording the virtual representation. Particularly in the field of dentistry, if three-dimensional shapes such as teeth are involved, data of the STL variety are used. STL files render three-dimensional surface geometries in the form of polygon nets, where each polygon of the net is usually a triangle which is defined by its three corners and the surface normal of the triangle. The corners are generally given in Cartesian coordinates.

After recording 4, changes can optionally be made to the object 5. For example, teeth from which an impression was previously made, can be prepared for crowning.

Once the virtual representation has been recorded on a storage medium, it can be recalled at any desired time. To this end, it is read from the storage medium and loaded 6.

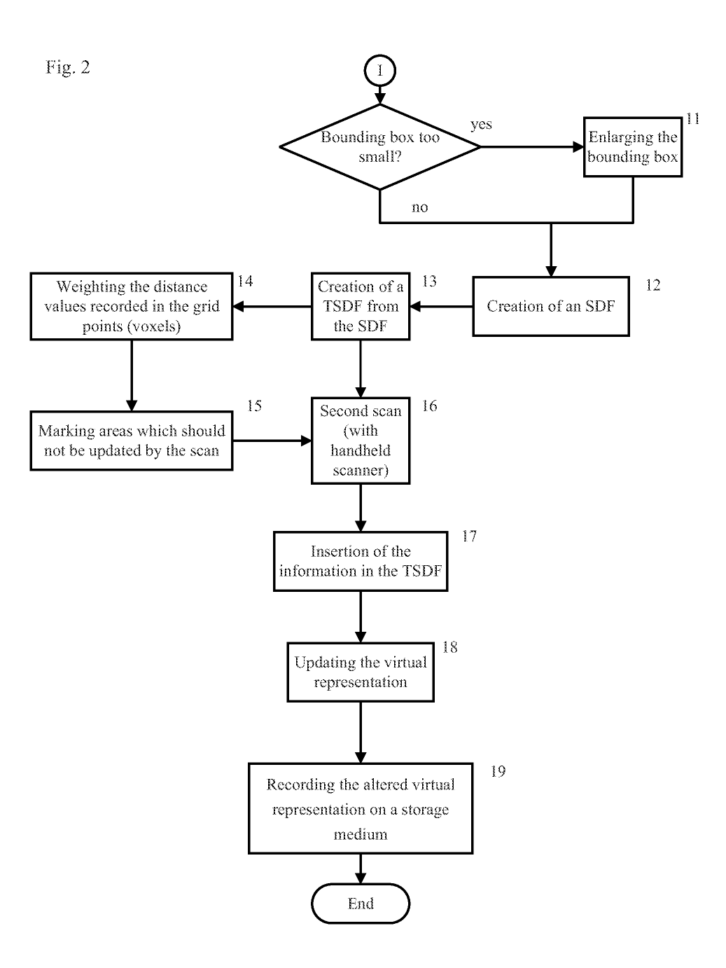

In the next step 7, a bounding box is first determined for the loaded virtual representation. This is then aligned 8 along the main axes of the STL or the STL model. Then the bounding box is discretized 9, preferably equidistantly and along Cartesian coordinate axes. Optionally, the virtual representation can then be aligned according to the bounding box 10. Optionally, the bounding box can then be enlarged in a next step 11 (FIG. 2). This can, for example, be advantageous because the virtual representation extends outside of the bounding box due to aligning, or because only part of the object was captured in the first scan, or also because one wishes to capture the scanner geometry or the positions of the scanner during the scan along with the object.

In a next step 12, an SDF (signed distance function) is generated. To this end, the distances from the grid points or voxels which were generated during discretizing (step 9) to the virtual representation along a chosen axial direction (typically in the direction of the z-axis) are measured. For grid points which lie ahead of the virtual representation along the chosen axial direction, the distance value is recorded as being positive. For grid points which lie behind the virtual representation along the chosen axial direction, the distance value is recorded as being negative.

Since it has been shown to be advantageous to work with a TSDF (truncated signed distance function) instead of an SDF, the next step 13 can be used to examine which distance values in the grid points or voxels surpass a certain value. For distance values whose absolute value lies below a certain value, the distance value remains the same. In voxels in which distance values are recorded whose absolute value surpasses the predetermined value, the distance values are set to the predetermined value. In the TSDF generated thereby, the distance values recorded in the voxels can be weighted 14. A possible implementation is described in greater detail in European patent submission No. 13 450 056.0. Weighting allows the precision of the data gathered in the first scan to be maintained even when adding new gathered data, and nonetheless remain flexible with regard to notation. Optionally, areas of the virtual representation which should not be updated can also be marked 15, for instance because the precision of these areas is already so high that it is probable that additional data definitely would or could represent a downgrade.

Thereafter, a second scan is performed 16. New information about the surface geometry of the object is thereby gained. This information can on the one hand be new, because the relevant areas of the object were altered in step 5, or on the other hand, because areas of the object were captured which were not captured by the first scan. The newly gained information is then inserted 17 into the previously generated TSDF steps 7 through 13). By inserting 17 the data gained in the second scan into the TSDF, the virtual representation can be updated 18. The updated virtual representation is then recorded again 19.

1. Method for capturing the surface geometry of at least one part of an object, in particular of intraoral structures, from which a physical impression of at least one part of the object is first made, after which the surface geometry of the physical impression is then either directly, or indirectly via a positive impression, captured by means of a scanner during an initial scan, whereby a virtual representation of the physical impression is created, which is at least temporarily recorded on a storage medium, the method comprising:
uploading and providing the virtual representation from the storage medium,
performing a second scan of the object, during which at least one section of the object which was altered or not captured by the first scan of the physical impression is captured,
updating the virtual representation of the object with data which were gained by the second scan,
recording the altered virtual representation on a storage medium.

2. Method according to claim 1, wherein the first scan is performed by a stationary scanner.

3. Method according to claim 1, wherein the first scan is performed by a handheld scanner.

4. Method according to claim 1, wherein the second scan is performed by a handheld scanner.

5. Method according to claim 1, wherein the method includes the step:
visualization of the virtual representation.

6. Method according to claim 1, wherein the method includes the step:
transfer of the provided virtual representation to an expandable notation, in particular a TSDF.

7. Method according to claim 6, wherein the transfer includes the step:
determining a bounding box for the virtual representation.

8. Method according to claim 7, characterized in determining an axis-aligned bounding.

9. Method according to claims 7, wherein the transfer includes the step:
discretizing the bounding box.

10. Method according to claim 9, wherein discretization is performed equidistantly.

11. Method according to claim 7, wherein the transfer includes the step:
aligning the virtual representation in accordance with the bounding box.

12. Method according to claim 7, wherein the transfer includes the step:
enlarging the bounding box.

13. Method according to claim 9, wherein the transfer includes the step:
determining the distances of individual grid points of the discretized bounding box to a surface of the representation along a defined direction of the bounding box, and recording the gained distance values in individual grid points, thereby creating an SDF.

14. Method according to claim 13, wherein the transfer includes the step:
setting gathered distances which surpass a defined value to the defined value, thereby creating a TSDF.

15. Method according to claims 13, wherein the transfer includes the step:
changing the signs in the SDF or TSDF.

16. Method according to claim 13, wherein the transfer includes the step:
weighting of the distance values recorded in the grid points.

17. Method according to claim 1, wherein the method including the step:
marking of areas which should not be updated by scanning the altered object.

18. The method according to claim 2, wherein the second scan is performed by a handheld scanner.

19. The method according to claim 3, wherein the second scan is performed by a handheld scanner.

20. Method according to claim 2, wherein the method includes the step:
visualization of the virtual representation.
